(19) United States
(12) Patent Application Publication
(10) Pub. No.: US 2017/0335927 A1
(43) Pub. Date: Nov. 23, 2017

(54) POWER TRANSMISSION DEVICE

(71) Applicant: HONDA MOTOR CO., LTD., Tokyo (JP)

(72) Inventors: Jiro Obinata, Saitama (JP); Kazuma Hatakeyama, Saitama (JP); Yoshiharu Saito, Saitama (JP)

(73) Assignee: HONDA MOTOR CO., LTD., Tokyo (JP)

(21) Appl. No.: 15/523,982

(22) PCT Filed: Nov. 10, 2014
(86) PCT No.: PCT/JP2014/079703

§ 371 Date: May 3, 2017

(51) Int. Cl. F16H 3/097; B60K 17/30; B60K 17/348; B60K 17/16; F16H 3/093

(52) U.S. Cl. CPC F16H 3/097; B60K 17/348; B60K 17/16; B60K 17/30; F16H 2003/0938

(57) ABSTRACT

The power transmission device includes an internal-combustion engine 25, a drive-source-side shaft, a flywheel 30 provided on the drive-source-side shaft 2, a speed changer 10, which has an input shaft and an output, and clutches C1 and C2 capable of releasably transmitting the power between the drive-source-side shaft 2 and the input shaft, wherein the internal-combustion engine 25 and the speed changer 10 are disposed in the traveling direction of the vehicle. A differential gear mechanism 101 and a drive shaft 201, which are positioned between the flywheel 30 and the clutches C1 and C2 so as to be orthogonal to the drive-source-side shaft 2 and which transmit the power output from the speed changer 10 to left and right drive wheels RW, are provided. The drive shaft 201 is disposed above the central axis of rotation of the drive-source-side shaft 2.

### TECHNICAL FIELD

The present invention relates to a power transmission device.

### BACKGROUND ART

Hitherto, there has been known a vehicle in which a drive source and a power transmission device, such as a speed changer, are disposed at the rear of the vehicle (refer to, for example, Patent Literature 1).

The speed changer in Patent Literature 1 is longitudinally installed so as to match the axial direction thereof with the longitudinal direction of a vehicle. Further, Patent Literature 2 describes a vehicle having a power transmission device which is disposed on the front of a vehicle and provided with a speed changer that is longitudinally mounted.

### CITATION LIST

### Patent Literature

Patent Literature 1: PCT International Publication No. WO2000/05094

Patent Literature 2: Japanese Examined Patent Application Publication No. 7-8610

### SUMMARY OF INVENTION

### Technical Problem

To maintain predetermined cornering performance of a vehicle, the wheelbase of a vehicle cannot be increased. There are cases where, once the wheelbase is decided, the space available for placing a power transmission device is limited when a drive source, such as an internal-combustion engine or an electric motor, is disposed between a drive-wheel-side shaft, such as the drive shaft of the rear wheels of the vehicle, and a seat.

The drive source could be disposed on an upper level and the components of the power transmission device and peripheral equipment could be disposed under the drive source. However, positioning the rotating shaft of the drive source under the drive-wheel-side shaft, such as the drive shaft, causes the center of gravity of the vehicle to be lower, thus improving the stability of the vehicle.

In view of the background described above, an object of the present invention is to provide a power transmission device capable of maintaining a predetermined wheelbase without impairing the stability of a vehicle.

### SOLUTION TO PROBLEM

[1] To this end, a power transmission device according to the present invention includes:

a drive source mounted in a vehicle;

a drive-source-side shaft to which the power of the drive source is output;

a flywheel provided on the drive-source-side shaft;

a speed changer which has an input shaft and an output shaft, and which is capable of changing the rotational speed of the input shaft and outputting the changed rotational speed from the output shaft; and

a clutch capable of releasably transmitting power between the drive-source-side shaft and the input shaft,

wherein the rotating shafts of the drive source and the speed changer are disposed in the same direction as the longitudinal direction of the vehicle,

a differential gear mechanism and a drive-wheel-side shaft which are positioned between the flywheel and the clutch so as to be orthogonal to the axial direction of the input shaft and which transmit the power output from the output shaft to left and right drive wheels are provided, and

the drive-wheel-side shaft is disposed above the central axis of rotation of the drive-source-side shaft.

According to the present invention, in the longitudinal power transmission device, the drive-wheel-side shaft is disposed between the flywheel and the clutch and above the central axis of rotation of the drive-source-side axis, thus enabling the central axis of rotation of the drive source to be disposed at a low position. Further, the drive-wheel-side shaft is positioned between the flywheel and the clutch. Hence, a predetermined wheelbase of a vehicle can be maintained, as compared with a case where the drive-wheel-side shaft is positioned between the clutch and the speed changer.

[2] Preferably, the input shaft and the output shaft are disposed in parallel to each other with an interval provided therebetween, power is transmitted between the input shaft and the output shaft through a plurality of gear trains composed of drive gears provided on the input shaft and driven gears provided on the output shaft, the output shaft is provided with an output gear, the output gear is disposed at a position closest to the differential gear mechanism among the gears disposed on the output shaft, a first gear for transmission meshes with the output gear, the first gear for transmission is journaled by a transmission shaft, the differential gear mechanism includes a differential-side gear composed of an external tooth provided on an outer circumference, and the transmission shaft is provided with a second gear for transmission that meshes with the differential-side gear.

According to this configuration, the output gear is disposed at a position closest to the differential gear mechanism among the gears disposed on the output shaft, so that the transmission shaft can be configured with a shortest possible length, thus enabling a reduction in the size of the power transmission device.

[3] Preferably, an oil pump driven by the drive-source-side shaft is provided, the oil pump has an oil pump shaft disposed in parallel to the drive-source-side shaft, the drive-wheel-side shaft is disposed vertically above the drive-source-side shaft, and the oil pump shaft is disposed vertically under the drive-source-side shaft.

According to this configuration, the oil pump is placed under a drive-wheel-side shaft, such as a drive shaft, and a drive-source-side shaft, thus enabling the oil pump of a power transmission device to have improved performance of self-suction of oil. In other words, the oil pump is driven in an oil reservoir of oil that drops by its own weight.

[4] Preferably, the clutch is a wet clutch, and the wet clutch is lubricated by the oil supplied from the oil pump. This configuration makes it possible to place a lubrication system, which includes the oil pump and a hydraulic control circuit, in the vicinity of the wet clutch, thus permitting easier handling of a lubrication passage for supplying the oil to the wet clutch.

[5] Preferably, the second gear for transmission and the differential-side gear are composed of hypoid gears, and the meshing point between the second gear for transmission and the differential-side gear composed of the hypoid gears is positioned to correspond to the position of the clutch in an axial direction.

This arrangement permits a shorter transmission shaft than in the case where the meshing point is set between a differential gear mechanism and a drive source. In addition, the drive-wheel-side shaft and the transmission shaft do not overlap, so that a large space can be secured around the differential gear mechanism, thus enabling a higher degree of design freedom, including an increase in the capacity of the differential gear mechanism.

### BRIEF DESCRIPTION OF DRAWINGS

FIG. 1 is a skeleton diagram schematically illustrating an embodiment of a power transmission device according to the present invention;

FIG. 2 is a schematic diagram illustrating the power transmission device according to the present embodiment mounted in a vehicle;

FIG. 3 is a schematic diagram illustrating the power transmission device according to the present embodiment viewed from the rear; and

FIG. 4 is a skeleton diagram illustrating the section taken at line IV-IV of FIG. 3.

### DESCRIPTION OF EMBODIMENTS

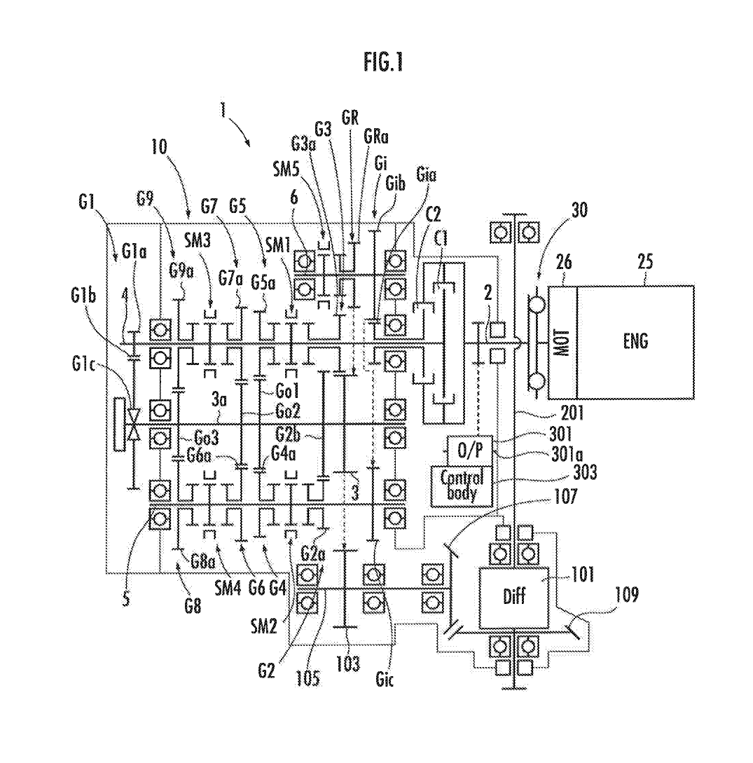

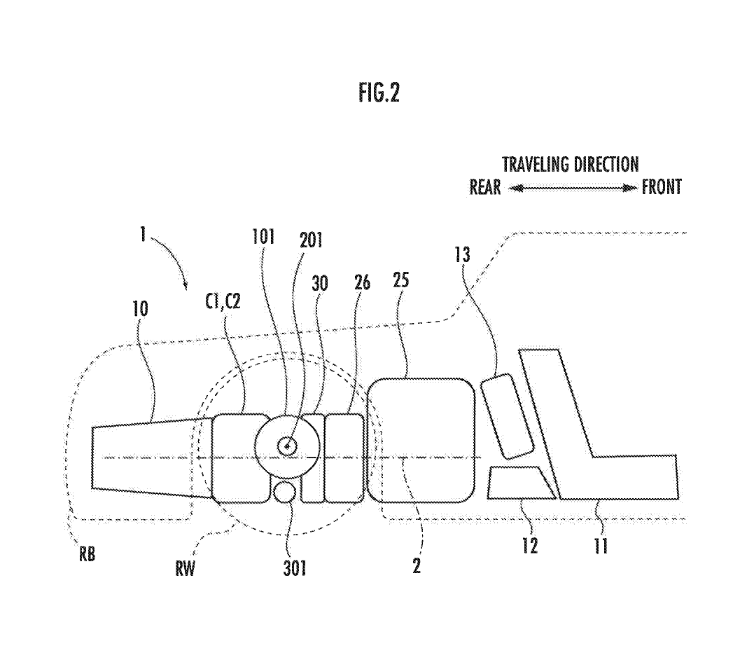

FIG. 1 illustrates a power transmission device 1 according to an embodiment of the present invention. The power transmission device 1 is used with a vehicle, such as an automobile, and includes a drive-source-side shaft 2, to which a driving force (output torque) of an internal-combustion engine 25 serving as a drive source, and a speed changer 10 that outputs power to the left and right rear wheels serving as drive wheels RW (refer to FIG. 2) through the intermediary of a differential gear mechanism 101. The drive-source-side shaft 2 is provided with a flywheel 30 that functions also as a damper. In the present embodiment, the central axis of rotation of a crankshaft of the internal-combustion engine 25 corresponds to the rotation axis of a drive source in the present invention.

The speed changer 10 includes an output shaft 3a (driven shaft), which has an output gear 3, and a plurality of gear trains G1 to G9 having different gear ratios. The internal-combustion engine 25 is provided with an electric motor 26. The driving force of the electric motor 26 can be used for a vehicle to travel. The front wheels may be driven or regeneratively braked by an electric motor that is separate from the electric motor 26.

Further, the speed changer 10 includes a first drive shaft 4 (a first input shaft), which rotatably journals drive gears G3a, G5a, G7a and G9a of odd-numbered gear trains G3, G5, G7 and G9, which establish odd-numbered shift stages in a gear ratio order, a second drive shaft 5 (a second input shaft), which rotatably journals drive gears G2a, G4a, G6a and G8a of even-numbered gear trains G2, G4, G6 and G8, which establish even-numbered shift stages in the gear ratio order, and a reverse shaft 6 (intermediate shaft) rotatably journaling a reverse drive gear GRa of a reverse stage gear train GR composed of the reverse drive gear GRa used for establishing the reverse stage and the output gear 3 functioning also as a reverse driven gear. The first drive shaft 4 (the first input shaft) is disposed on the same axis line as the drive-source-side shaft 2, and the second drive shaft 5 (the second input shaft) is disposed in parallel to the first drive shaft 4. In the present embodiment, the first drive shaft 4 (the first input shaft) and the second drive shaft 5 (the second input shaft) correspond to the input shaft in the present invention. Further, in the present embodiment, the first drive shaft 4 (the first input shaft), the second drive shaft 5 (the second input shaft), and the output shaft 3a (the driven shaft) correspond to the rotating shaft of the speed changer in the present invention.

Further, a first speed drive gear G1a constituting a first speed gear train G1 is fixed to the first drive shaft 4 (the first input shaft). A first speed driven gear G1b constituting a first speed gear train G1 is rotatably journaled on the output shaft 3a (the driven shaft) through the intermediary of a one-way clutch G1c. The first speed drive gear G1a and the first speed driven gear G1b mesh with each other.

Further, the speed changer 10 has an idle gear train G1 composed of an idle drive gear Gia rotatably journaled by the first drive shaft 4 (the first input shaft), a first idle driven gear Gib, which meshes with the idle drive gear Gia and which is fixed to the reverse shaft 6, and a second idle driven gear Gic, which meshes with the first idle driven gear Gib and which is fixed to the second drive shaft 5 (the second input shaft).

The power transmission device 1 has a first clutch C1 and a second clutch C2, which are composed of hydraulically operated wet friction clutches. The first clutch C1 is configured to be switchable between a transmission mode, in which the driving force of the internal-combustion engine 25 transmitted to the drive-source-side shaft 2 is transmitted to the first drive shaft 4 (the first input shaft), and a release mode, in which the transmission is cut off. The second clutch C2 is configured to be switchable between the transmission mode, in which the driving force of the internal-combustion engine 25 transmitted to the drive-source-side shaft 2 is transmitted to the second drive shaft 5 (the second input shaft) through the intermediary of the idle gear train Gi, and the release mode, in which the transmission is cut off.

The modes of both the clutches C1 and C2 are switched by clutch hydraulic actuators, which are not illustrated. Further, the fastening pressures in the transmission modes can be adjusted by the clutch hydraulic actuators, which are not illustrated (the so-called “half clutch” state can be established).

The reverse drive gear GRa of the reverse stage gear train GR is rotatably journaled by the reverse shaft 6. The output gear 3 meshes with the reverse drive gear GRa and functions also as the reverse driven gear. Further, the output gear 3 meshes also with a third speed drive gear G3a, which is rotatably journaled by the first drive shaft 4 (the first input shaft), and functions also as a third speed driven gear.

A second speed driven gear G2b, which meshes with a second speed drive gear G2a, is fixed to the output shaft 3a, which journals the output gear 3. Fixed onto the output shaft 3a are a first driven gear Go1, which meshes with a fourth speed drive gear G4a and a fifth speed drive gear G5a, a second driven gear Go2, which meshes with a sixth speed drive gear G6a and a seventh speed drive gear G7a, and a third driven gear Go3, which meshes with an eighth speed drive gear G8a and a ninth speed drive gear G9a.

As described above, the reverse stage gear train GR and the driven gear of a third speed gear train G3 are constituted of the output gear 3, and the driven gears of the fourth speed gear train G4 and the fifth speed gear train G5 are constituted of the single gear Go1, the driven gears of the sixth speed gear train G6 and the seventh speed gear train G7 are constituted of the single Go2, and the driven gears of the eighth speed gear train G8 and the ninth speed gear train G9 are constituted of the single Go3. This arrangement makes it possible to shorten the axial length (the axial dimension) of the power transmission device 1, thus enabling the power transmission device 1 to be mounted on a vehicle with greater ease.

The first drive shaft 4 is provided with a first meshing mechanism SM1, which is composed of a synchronous meshing mechanism and which is switchable to any one of a third speed side connection mode, in which the third speed drive gear G3a and the first drive shaft 4 are connected, a fifth speed side connection mode, in which the fifth speed drive gear G5a and the first drive shaft 4 are connected, and a neutral mode, in which the connection between the third speed drive gear G3a and the fifth speed drive gear G5a and the first drive shaft 4 is released.

The second drive shaft 5 is provided with a second meshing mechanism SM2, which is composed of a synchronous meshing mechanism and which is switchable to any one of a second speed side connection mode, in which the second speed drive gear G2a and the second drive shaft 5 are connected, a fourth speed side connection mode, in which the fourth speed drive gear G4a and the second drive shaft 5 are connected, and a neutral mode, in which the connection between the second speed drive gear G2a and the fourth speed drive gear G4a and the second drive shaft 5 is released.

The first drive shaft 4 is provided with a third meshing mechanism SM3, which is composed of a synchronous meshing mechanism and which is switchable to any one of a seventh speed side connection mode, in which the seventh speed drive gear G7a and the first drive shaft 4 are connected, a ninth speed side connection mode, in which the ninth speed drive gear G9a and the first drive shaft 4 are connected, and a neutral mode, in which the connection between the seventh speed drive gear G7a and the ninth speed drive gear G9a and the first drive shaft 4 is released.

The second drive shaft 5 is provided with a fourth meshing mechanism SM4, which is composed of a synchronous meshing mechanism and which is switchable to any one of a sixth speed side connection mode, in which the sixth speed drive gear G6a and the second drive shaft 5 are connected, an eighth speed side connection mode, in which the eighth speed drive gear G8a and the second drive shaft 5 are connected, and a neutral mode, in which the connection between the sixth speed drive gear G6a and the eighth speed drive gear G8a and the second drive shaft 5 is released.

The reverse shaft 6 (the intermediate shaft) is provided with a fifth meshing mechanism SM5, which is composed of a synchronous meshing mechanism and which is switchable to either a connection mode, in which the reverse drive gear GRa and the reverse shaft 6 are connected, or a neutral mode, in which the connection is released.

A description will now be given of the operation of the power transmission device 1 according to the present embodiment. In the power transmission device 1 according to the present embodiment, the first speed stage is established by setting the first clutch C1 to the transmission mode and the second clutch C2 to the release mode. When starting a vehicle, the rotational speed of the first speed driven gear G1b of the first speed gear train G1 becomes higher than the rotational speed of the output shaft 3a (the driven shaft).

Therefore, the one-way clutch G1c disposed between the first speed driven gear G1b and the output shaft 3a is locked and the rotational speed of the output shaft 3a becomes the same as the rotational speed of the first speed driven gear G1b, thus establishing the first speed stage. When the rotational speed of the output shaft 3a exceeds the rotational speed of the first speed driven gear G1b, the one-way clutch G1c idles, cutting off the transmission of the driving force from the first speed gear train G1.

Further, if a control unit, such as an ECU, which is not illustrated, predicts an upshift to the second speed stage while the vehicle is traveling at the first speed stage on the basis of vehicle information, including the vehicle speed and the opening of an accelerator pedal, then the second meshing mechanism SM2 is set to the second speed side connection mode, in which the second speed drive gear G2a and the second drive shaft 5 are connected, or to a pre-shift mode for bringing the second meshing mechanism SM2 close to the second speed side connection mode.

To establish the second speed stage by using the driving force of the internal-combustion engine 25, the second meshing mechanism SM2 is set to the second speed side connection mode, in which the second speed drive gear G2a and the second drive shaft 5 are connected, the first clutch C1 is set to the release mode, and the second clutch C2 is fastened into the transmission mode. This causes the driving force of the internal-combustion engine 25 to be output from the output gear 3 via the second clutch C2, the idle gear train Gi, the second drive shaft 5, the second speed gear train G2, and the output shaft 3a.

At the second stage speed, if the control unit (not illustrated) of the power transmission device 1 predicts an upshift, then the first meshing mechanism SM1 is set to the third speed side connection mode, in which the third speed drive gear G3a and the first drive shaft 4 are connected, or to a pre-shift mode for bringing the first meshing mechanism SM1 close to the third speed side connection mode. This enables the upshift to be accomplished merely by setting the first clutch C1 to the transmission mode and the second clutch C2 to the release mode, thus permitting a smooth speed stage shift without an interruption of the driving force.

Conversely, if the control unit (not illustrated) predicts a downshift, then the first meshing mechanism SM1 is set to the neutral mode in which the connection between the third speed drive gear G3a and the fifth speed drive gear G5a and the first drive shaft 4 is released, and the third meshing mechanism SM3 is set to the neutral mode in which the connection between the seventh speed drive gear G1a and the ninth speed drive gear G9a and the first drive shaft 4 is released.

The first speed driven gear G1b is provided on the output shaft 3a (the driven shaft) through the intermediary of the one-way clutch G1c, so that even when the first clutch C1 is set to the transmission mode and the second clutch C2 is set to the release mode, the downshift to the first speed stage cannot be accomplished until the rotational speed of the output shaft 3a reduces to be lower than the rotational speed of the first speed driven gear G1b. In this case, a smooth downshift to the first speed stage can be accomplished by, for example, reducing the vehicle speed by performing the regenerative braking using an electric motor that is separate from the electric motor 26 provided on the front wheels so as to promptly reduce the rotational speed of the output shaft 3a.

To establish the third speed stage by using the driving force of the internal-combustion engine 25, the first meshing mechanism SM1 is set to the third speed side connection mode, in which the third speed drive gear G3a and the first drive shaft 4 are connected, the second clutch C2 is set to the release mode, and the first clutch C1 is fastened into the transmission mode. This causes the driving force of the internal-combustion engine 25 to be output from the output gear 3 through the intermediary of the drive-source-side shaft 2, the first clutch C1, the first drive shaft 4, the first meshing mechanism SM1, and the third speed gear train G3.

At the third speed stage, if the control unit (not illustrated) of the power transmission device 1 predicts a downshift on the basis of vehicle information, such as the vehicle speed or the opening of the accelerator pedal, then the second meshing mechanism SM2 is set to the second speed side connection mode, in which the second speed drive gear G2a and the second drive shaft 5 are connected, or to a pre-shift mode for bringing the second meshing mechanism SM2 close to the second speed side connection mode. If an upshift is predicted, then the second meshing mechanism SM2 is set to the fourth speed side connection mode, in which the fourth speed drive gear G4a and the second drive shaft 5 are connected, or to a pre-shift mode for bringing the second meshing mechanism SM2 close to the fourth speed side connection mode.

This enables the speed stage shift to be accomplished merely by fastening the second clutch C2 into the transmission mode and releasing the first clutch C1 into the release mode, thus permitting a smooth speed stage shift without an interruption of the driving force.

To establish the fourth speed stage by using the driving force of the internal-combustion engine 25, the second meshing mechanism SM2 is set to the fourth speed side connection mode, in which the fourth speed drive gear G4a and the second drive shaft 5 are connected, the first clutch C1 is set to the release mode, and the second clutch C2 is fastened into the transmission mode.

While the vehicle is traveling at the fourth speed stage, if the control unit predicts a downshift on the basis of vehicle information, the first meshing mechanism SM1 is set to the third speed side connection mode, in which the third speed drive gear G3a and the first drive shaft 4 are connected, or to the pre-shift mode for bringing the first meshing mechanism SM1 close to the third speed side connection mode.

Conversely, if the control unit predicts an upshift on the basis of the vehicle information, then the first meshing mechanism SM1 is set to the fifth speed side connection mode, in which the fifth speed drive gear G5a and the first drive shaft 4 are connected, or to the pre-shift mode for bringing the first meshing mechanism SM1 close to the fifth speed side connection mode. This enables the downshift or the upshift to be accomplished merely by fastening the first clutch C1 into the transmission mode and releasing the second clutch C2 into the release mode, thus permitting a smooth speed change without an interruption of the driving force.

To establish the fifth speed stage by using the driving force of the internal-combustion engine 25, the first meshing mechanism SM1 is set to the fifth speed side connection mode, in which the fifth speed drive gear G5a and the first drive shaft 4 are connected, the second clutch C2 is set to the release mode, and the first clutch C1 is fastened into the transmission mode.

While the vehicle is traveling at the fifth speed stage, if the control unit predicts a downshift to the fourth speed stage on the basis of vehicle information, then the second meshing mechanism SM2 is set to the fourth speed side connection mode, in which the fourth speed drive gear G4a and the second drive shaft 5 are connected, or to the pre-shift mode for bringing the second meshing mechanism SM2 close to the fourth speed side connection mode. Conversely, if an upshift is predicted, then the fourth meshing mechanism SM4 is set to the sixth speed side connection mode, in which the sixth speed drive gear G6a and the second drive shaft 5 are connected, or to the pre-shift mode for bringing the fourth meshing mechanism SM4 close to the sixth speed side connection mode. With this, changing a shift stage can be accomplished merely by fastening the second clutch C2 into the transmission mode and releasing the first clutch C1 into the release mode, thus permitting a smooth speed change without an interruption of the driving force.

To establish the sixth speed stage by using the driving force of the internal-combustion engine 25, the fourth meshing mechanism SM4 is set to the sixth speed side connection mode, in which the sixth speed drive gear G6a and the second drive shaft 5 are connected, the first clutch C1 is set to the release mode, and the second clutch C2 is fastened into the transmission mode.

While the vehicle is traveling at the sixth speed stage, if the control unit predicts a downshift to the fifth speed stage on the basis of vehicle information, then the first meshing mechanism SM1 is set to the fifth speed side connection mode, in which the fifth speed drive gear G5a and the first drive shaft 4 are connected, or to the pre-shift mode for bringing the first meshing mechanism SM1 close to the fifth speed side connection mode. Conversely, if an upshift is predicted, then the third meshing mechanism SM3 is set to the seventh speed side connection mode, in which the seventh speed drive gear G7a and the first drive shaft 4 are connected, or to the pre-shift mode for bringing the third meshing mechanism SM3 close to the seventh speed side connection mode. With this, the downshift or the upshift can be accomplished merely by fastening the first clutch C1 into the transmission mode and releasing the second clutch C2 into the release mode, thus permitting a smooth speed change without an interruption of the driving force.

To establish the seventh speed stage by using the driving force of the internal-combustion engine 25, the third meshing mechanism SM3 is set to the seventh speed side connection mode, in which the seventh speed drive gear G7a and the first drive shaft 4 are connected, the second clutch C2 is set to the release mode, and the first clutch C1 is fastened into the transmission mode.

While the vehicle is traveling at the seventh speed stage, if the control unit predicts a downshift to the sixth speed stage on the basis of vehicle information, then the fourth meshing mechanism SM4 is set to the sixth speed side connection mode, in which the sixth speed drive gear G6a and the second drive shaft 5 are connected, or to the pre-shift mode for bringing the fourth meshing mechanism SM4 close to the sixth speed side connection mode. Conversely, if an upshift is predicted, then the fourth meshing mechanism SM4 is set to the eighth speed side connection mode, in which the eighth speed drive gear G8a and the second drive shaft 5 are connected, or to the pre-shift mode for bringing the fourth meshing mechanism SM4 close to the eighth speed side connection mode. With this, the speed stage shift can be accomplished merely by fastening the second clutch C2 into the transmission mode and releasing the first clutch C1 into the release mode, thus permitting a smooth speed change without an interruption of the driving force.

To establish the eighth speed stage by using the driving force of the internal-combustion engine 25, the fourth meshing mechanism SM4 is set to the eighth speed side connection mode, in which the eighth speed drive gear G8a and the second drive shaft 5 are connected, the first clutch C1 is set to the release mode, and the second clutch C2 is fastened into the transmission mode.

While the vehicle is traveling at the eighth speed stage, if the control unit predicts a downshift to the seventh speed stage on the basis of vehicle information, then the third meshing mechanism SM3 is set to the seventh speed side connection mode, in which the seventh speed drive gear G7a and the first drive shaft 4 are connected, or to the pre-shift mode for bringing the third meshing mechanism SM3 close to the seventh speed side connection mode. Conversely, if an upshift is predicted, then the third meshing mechanism SM3 is set to the ninth speed side connection mode, in which the ninth speed drive gear G9a and the first drive shaft 4 are connected, or to the pre-shift mode for bringing the third meshing mechanism SM3 close to the ninth speed side connection mode. With this, the downshift or the upshift can be accomplished merely by fastening the first clutch C1 into the transmission mode and releasing the second clutch C2 into the release mode, thus permitting a smooth speed change without an interruption of the driving force.

To establish the ninth speed stage by using the driving force of the internal-combustion engine 25, the third meshing mechanism SM3 is set to the ninth speed side connection mode, in which the ninth speed drive gear G9a and the first drive shaft 4 are connected, the second clutch C2 is set to the release mode, and the first clutch C1 is fastened into the transmission mode.

While the vehicle is traveling at the ninth speed stage, if the control unit predicts a downshift to the eighth speed stage on the basis of vehicle information, then the fourth meshing mechanism SM4 is set to the eighth speed side connection mode, in which the eighth speed drive gear G8a and the second drive shaft 5 are connected, or to the pre-shift mode for bringing the fourth meshing mechanism SM4 close to the eighth speed side connection mode. With this, the downshift to the eighth speed stage can be accomplished merely by fastening the second clutch C2 into the transmission mode and releasing the first clutch C1 into the release mode, thus permitting a smooth speed change without an interruption of the driving force.

To establish the reverse stage by using the driving force of the internal-combustion engine 25, the fifth meshing mechanism SM5 is set to the connection mode, in which the reverse drive gear GRa and the reverse shaft 6 are connected, the second clutch C2 is fastened into the transmission mode, and the first clutch C1 is set to the release mode. This causes the driving force of the internal-combustion engine 25 to be output from the output gear 3 through the intermediary of the drive-source-side shaft 2, the second clutch C2, the reverse shaft 6, the fifth meshing mechanism SM5, and the reverse drive gear GRa, thus establishing the reverse stage.

The output gear 3 meshes with a first transmission gear 103 to transmit the driving force to a differential gear mechanism 101. The output gear 3 and the first transmission gear 103 are the portions that transmit the driving force at all times in the driving force transmission path, so that the widths of their teeth (tooth width) are set to be relatively wider than those of other gears.

The first transmission gear 103 is journaled on a transmission shaft 105 to rotate integrally therewith. Further, a differential-side gear 109 is provided on the outer periphery of the differential gear mechanism 101. A second transmission gear 107, which meshes with the differential-side gear 109, is journaled on the transmission shaft 105 to integrally rotate therewith. The power output from the differential gear mechanism 101 is transmitted to a drive shaft 201 acting as the drive-wheel-side shaft, thus causing the left and right drive wheels RW (refer to FIG. 2) to rotate.

The second transmission gear 107 and the differential-side gear 109, which mesh with each other, are composed of hypoid gears. The hypoid gears are a type of spiral bevel gears, and the transmission shaft 105 is positioned between the outside diameter and the central line of the differential-side gear 109.

The meshing point between the second transmission gear 107 and the differential-side gear 109, i.e. the meshing point of the hypoid gears, is positioned to match the clutches C1 and C2 in the axial direction of the transmission shaft 105. This is because, if the meshing point were set closer to the internal-combustion engine 25 than the drive shaft 201, then the degree of freedom of the layout of the differential gear mechanism 101 would be reduced, due to, for example, an increase in the length of the transmission shaft 105 and the need for avoiding the drive shaft 201 and the differential gear mechanism 101 when placing the transmission shaft 105, and the capacity of the differential gear mechanism 101 cannot be increased. According to the present embodiment, matching the meshing point to the clutches C1 and C2 makes it possible to increase the capacity of the differential gear mechanism 101 to survive the transmission of a relatively large torque, and the degree of freedom of the layout of the differential gear mechanism 101 can be improved.

FIG. 2 schematically illustrates the rear of the vehicle provided with the power transmission device according to the present embodiment, which is viewed sideways. The chain line in FIG. 2 indicates the central axis of rotation of the drive-source-side shaft 2 that is concentric with the rotational center of the crankshaft of the internal-combustion engine 25. As is obvious from FIG. 2, the drive shaft 201 serving as the drive-wheel-side shaft is positioned above the drive-source-side shaft 2.

Further, an oil pump 301 is disposed under the drive shaft 201. This permits effective use of the space under the drive shaft 201. As illustrated in FIG. 1, the oil pump 301 is actuated by using the driving force of the drive-source-side shaft 2, which is rotated by the internal-combustion engine 25, through a belt, a chain or the like. The oil discharged from the oil pump 301 is supplied to a hydraulic control circuit 303. The oil pump 301 is provided with an oil pump shaft 301a. The oil pump shaft 301a is disposed in parallel to the drive-source-side shaft 2.

Oil is supplied from the oil pump 301 to the clutches C1 and C2 through the hydraulic control circuit 303, and the supplied oil lubricates the plates of the clutches C1 and C2.

As illustrated in FIG. 2, a fuel tank 12 is disposed at the rear of a seat 11 of the vehicle provided with the power transmission device 1 according to the present embodiment. Further, a secondary battery 13 is disposed above the fuel tank 12. Disposed behind the fuel tank 12 and the secondary battery 13 are the internal-combustion engine 25, the electric motor 26, the flywheel 30, the drive shaft 201, the clutches C1 and C2, and the speed changer 10 in this order.

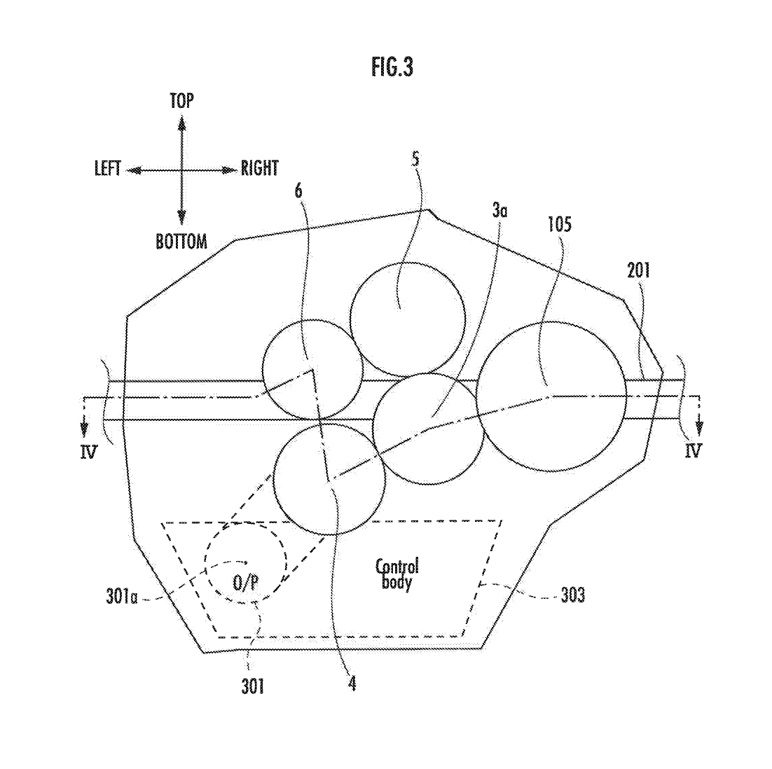

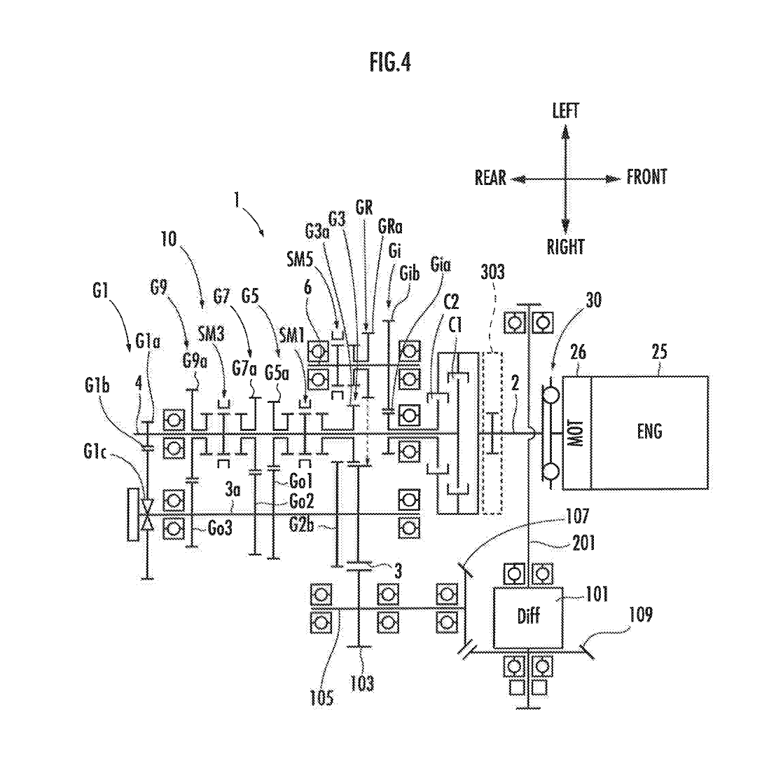

FIG. 3 is a schematic diagram illustrating the power transmission device according to the present embodiment, which is viewed from the rear. FIG. 4 is a skeleton diagram illustrating a section taken at line IV-IV in FIG. 3.

The cornering performance of the vehicle is influenced by the wheelbase, which is the distance between the axle of the front wheels and the drive shaft 201 of the rear wheels RW. In order to maintain predetermined cornering performance of the vehicle, the wheelbase is required to be maintained at a predetermined length. Placing the drive shaft of the rear wheels and the differential gear mechanism between the clutches C1, C2 and the speed changer 10 would require that the fuel tank 12, the secondary battery 13, the internal-combustion engine 25, the electric motor 26, the flywheel 30, and the clutches C1, C2 be disposed between the drive shaft and the seat 11. This may lead to an impractical layout, depending on the wheelbase that has been set.

A conceivable solution to the above-mentioned problem is to dispose the internal-combustion engine 25 at an upper level and other parts of the power transmission device 1 and peripheral equipment, such as auxiliary units, are disposed under the internal-combustion engine 25. However, placing the internal-combustion engine 25 at the upper level of the vehicle would cause the center of gravity of the vehicle to be positioned at a higher level, and therefore the stability of the vehicle may be impaired.

Therefore, in the power transmission device 1 according to the present embodiment, the drive shaft 201 is disposed between the flywheel 30 and the clutches C1, C2 as illustrated in FIG. 2. This eliminates the need for placing the clutches C1, C2 between the drive shaft 201 and the seat 11, and the wheelbase can be maintained at a predetermined length by positioning the rotation center of the crankshaft of the internal-combustion engine 25 at a level that is lower than the drive shaft 201.

Further, the differential gear mechanism 101 will be placed at the same position as that of the drive shaft 201, so that the constituent components of the speed changer 10 will not be in the way, thus enabling the differential gear mechanism 101 having a relatively large capacity to be used. Thus, a relatively large driving force can be transmitted to the differential gear mechanism 101.

Further, in the power transmission device 1 according to the present embodiment, among the gears provided on the output shaft 3a, the output gear 3 is disposed to be closest to the internal-combustion engine 25 acting as the drive source. This makes it possible to also position the reverse drive gear GRa, which meshes with the output gear 3, close to the internal-combustion engine 25, so that the lengths of the transmission shaft 105 and the reverse shaft 6 can be decreased, thus enabling the size of the power transmission device 1 to be reduced.

Further, the output gear 3 is disposed on the internal-combustion engine 25 side, so that the first transmission gear 103 can be also disposed on the internal-combustion engine 25 side. In addition, the differential gear mechanism 101 is also disposed on the internal-combustion engine 25 side. Accordingly, the transmission shaft 105, which journals the first transmission gear 103 and transmits the driving force to the differential gear mechanism 101, can be made shorter, thus enabling the size of the power transmission device 1 to be reduced.

As described above, the reduced size of the power transmission device 1 makes it possible to reduce the weight of the power transmission device 1 and to make the distance from the drive shaft 201 of the rear wheels RW to a rear bumper RB relatively short. In addition, the appearance of the vehicle can be prevented from being impaired by the clutches C1 and C2 disposed farther to the rear than the drive shaft 201.

The description has been given of the present embodiment that uses a dual clutch transmission as the speed changer 10 of the power transmission device. However, the speed changer in the present invention is not limited to the dual clutch transmission, and may alternatively be a different type insofar as it is capable of changing speed.

Further, in the present embodiment, the description has been given of the power transmission device 1 provided with the electric motor 26. However, the electric motor 26 may be omitted. Conversely, the internal-combustion engine 25 may be omitted, leaving the electric motor 26 in. In this case, the electric motor 26 corresponds to the drive source in the present invention.

### DESCRIPTION OF REFERENCE NUMERALS

1 power transmission device

2 drive-source-side shaft

3 output gear (common gear)

3a output shaft (driven shaft)

4 first drive shaft (first input shaft)

5 second drive shaft (second input shaft)

6 reverse shaft (intermediate shaft)

10 speed changer

11 seat

12 fuel tank

13 secondary battery

25 internal-combustion engine (drive source)

26 electric motor

30 flywheel

101 differential gear mechanism

103 first transmission gear

105 transmission shaft

107 second transmission gear

109 differential-side gear

201 drive shaft (drive-wheel-side shaft)

301 oil pump

301a oil pump shaft

303 hydraulic control circuit

C1 first clutch

C2 second clutch

SM1 first meshing mechanism

SM2 second meshing mechanism

SM3 third meshing mechanism

SM4 fourth meshing mechanism

SM5 fifth meshing mechanism

SM6 sixth meshing mechanism

G1 first speed gear train

G1a first speed drive gear

G1b first speed driven gear

G1c one-way clutch

G2 second speed gear train

G2a second speed drive gear

G2b second speed driven gear

G3 third speed gear train

G3a third speed drive gear

G4 fourth speed gear train

G4a fourth speed drive gear

G5 fifth speed gear train

G5a fifth speed drive gear

Go1 first driven gear (fourth speed/fifth speed driven gear)

Go2 second driven gear (sixth speed/seventh speed driven gear)

Go3 third driven gear (eight speed/ninth speed driven gear)

Gi idle gear train

Gia idle drive gear

Gib first idle driven gear

Gic second idle driven gear

GR reverse stage gear train

GRa reverse drive gear

RW drive wheel (rear wheel)

RB rear bumper

1. A power transmission device comprising:
a drive source mounted in a vehicle;
a drive-source-side shaft to which power of the drive source is output;
a flywheel provided on the drive-source-side shaft;
a speed changer which has an input shaft and an output shaft, and which is capable of changing a rotational speed of the input shaft and outputting the changed rotational speed from the output shaft; and
a clutch capable of releasably transmitting power between the drive-source-side shaft and the input shaft,
wherein the rotating shafts of the drive source and the speed changer are disposed in same direction as a longitudinal direction of the vehicle,
a differential gear mechanism and a drive-wheel-side shaft which are positioned between the flywheel and the clutch so as to be orthogonal to an axial direction of the input shaft and which transmit the power output from the output shaft to left and right drive wheels are provided, and
the drive-wheel-side shaft is disposed above a central axis of rotation of the drive-source-side shaft.

2. The power transmission device according to claim 1,
wherein the input shaft and the output shaft are disposed in parallel to each other with an interval provided therebetween,
power is transmitted between the input shaft and the output shaft through a plurality of gear trains composed of drive gears provided on the input shaft and driven gears provided on the output shaft,
the output shaft is provided with an output gear,
the output gear is disposed at a position closest to the differential gear mechanism among the gears disposed on the output shaft,
a first gear for transmission meshes with the output gear,
the first gear for transmission is journaled by a transmission shaft,
the differential gear mechanism includes a differential-side gear composed of an external tooth provided on an outer circumference, and
the transmission shaft is provided with a second gear for transmission that meshes with the differential-side gear.

3. The power transmission device according to claim 1, comprising:
an oil pump driven by the drive-source-side shaft,
wherein the oil pump has an oil pump shaft disposed in parallel to the drive-source-side shaft,
the drive-wheel-side shaft is disposed vertically above the drive-source-side shaft, and
the oil pump shaft is disposed vertically under the drive-source-side shaft.

4. The power transmission device according to claim 3,
wherein the clutch is a wet clutch, and
the wet clutch is lubricated by oil supplied from the oil pump.

5. The power transmission device according to claim 2,
wherein the second gear for transmission and the differential-side gear are composed of hypoid gears, and
a meshing point between the second gear for transmission and the differential-side gear composed of the hypoid gears is positioned to correspond to a position of the clutch in an axial direction.

6. The power transmission device according to claim 2, comprising:
an oil pump driven by the drive-source-side shaft,
wherein the oil pump has an oil pump shaft disposed in parallel to the drive-source-side shaft,
the drive-wheel-side shaft is disposed vertically above the drive-source-side shaft, and
the oil pump shaft is disposed vertically under the drive-source-side shaft.
